(19) United States
(12) Patent Application Publication
(10) Pub. No.: US 2020/0015619 A1
(43) Pub. Date: Jan. 16, 2020

(54) French Press

(71) Applicant: Prince H. Chimezie, Latham, NY (US)

(72) Inventor: Prince H. Chimezie, Latham, NY (US)

(21) Appl. No.: 16/031,022

(22) Filed: Jul. 10, 2018

(51) Int. Cl. A47J 31/38

(52) U.S. Cl. CPC A47J 31/38

(57) ABSTRACT

A French press is provided. The French press has a rotating lid having alternative pour options. Replaceable filters on the lid further allow a user to select the desired filter for use. A movable reservoir located within a housing of the French press traps most, if not all, of the coffee grounds from the interior of the French press. A valve plate stops the brewing process. The device may have two filters which are secured by a spring plate on top, and a cross plate below to form a filter assembly, which separates the coffee grounds from the brew. A plunger holds the filter assembly so that when pressed down, filtered coffee is separated from grounds, with the filter assembly acting as a barrier.

### BACKGROUND OF THE INVENTION

A French press is provided. The French press has a rotating lid having alternative pour options. Replaceable filters on the lid further allow a user to select the desired filter for use. A movable reservoir located within a housing of the French press traps most, if not all, of the coffee grounds from the interior of the French press. A valve plate stops the brewing process. The device may have two filters which are secured by a spring plate on top, and a cross plate below to form a filter assembly, which separates the coffee grounds from the brew. A plunger holds the filter assembly so that when pressed down, filtered coffee is separated from grounds, with the filter assembly acting as a barrier.

French presses have been patented in the past. For example, U.S. Pat. No. 9,320,383 to Sands discloses a French press combination grinder, filter, and drinking vessel, and method of making coffee. The system has a motor base, a container body, and two selectively removable container bases. The first removable container base has a blade, and the second removable container base has a plunger and filtering unit. Coffee beans are placed in the container body and ground when the first selectively removable container base is attached to the container body. Then, after the coffee is ground, the first base is removed and hot water is poured into the container body. The user then attaches the second container base and depresses the filtering unit to separate the coffee slurry into a liquid portion on top and coffee grounds portion on the bottom. The user may then drink the coffee directly from the same container that ground and filtered the coffee beans.

Further, U.S. Pat. No. 7,032,505 to Brady discloses a steeping apparatus for steeping a solid food material in a liquid to impart a flavor of the solid food material to the liquid to produce a flavored beverage. A container is provided to hold the solid food material and the liquid. The container forms an opening, through which the solid food material and the liquid are inserted into the container, and a spout at a peripheral of the opening, through which the flavored beverage is poured out of the container. A plunger is movable with respect to the container between a first plunger position and a second plunger position. A plunger moving element coupled to the plunger such that the plunger moves from the first plunger position to the second plunger position as the plunger moving element is moved. The plunger includes a filter element that, as the plunger moves from the first plunger position to the second plunger position, permits the flow of liquid therethrough but that substantially inhibits the passage of solid food material therethrough. A lid is coupled to the opening of the container. The lid further includes a secondary filter element located over the spout of the container.

Still further, U.S. Pat. No.: 9,192,261 to Katz et al discloses a French press coffee maker having a carafe, a plunger, and a ladle. The carafe includes a base wall and an upwardly extending generally cylindrical side wall. The plunger includes a rod and a piston connected to the rod. The piston is movable with respect to the carafe in an axial direction. The ladle includes a base having a peripheral rim and an upwardly extending arm connected with the base.

However, these French presses do not provide a French press which is easy to use, efficient and inexpensive as is disclosed in the present application.

### SUMMARY OF THE INVENTION

A French press is provided. The French press has a rotating lid having alternative pour options. Replaceable filters on the lid further allow a user to select the desired filter for use. A movable reservoir located within a housing of the French press traps most, if not all, of the coffee grounds from the interior of the French press. A valve plate stops the brewing process. The device may have two filters which are secured by a spring plate on top, and a cross plate below to form a filter assembly, which separates the coffee grounds from the brew. A plunger holds the filter assembly so that when pressed down, filtered coffee is separated from grounds, with the filter assembly acting as a barrier.

An advantage of the present French press is that the present French press allows a user to select between various pour options through various sized screens/filters used on the lid. A fine filter option prevents the grounds from being poured into a cup of coffee.

And an advantage of the present French press is that the lid of the present French press reduces heat loss by substantially closing the pour spout/mouth of the French press in one orientation. Further, the present lid helps prevent leakage which often occurs during pouring of coffee by use of silicon O-rings or gaskets which seal the edge of the lid to the French press body/carafe.

Another advantage of the present French press is that the present French press has a movable reservoir which catches coffee grounds. The present reservoir is removable making both disposal of coffee grounds and cleaning of the French press easier.

Still another advantage of the present French press is that the present French press has a valve plate which stops the brewing process.

For a more complete understanding of the above listed features and advantages of the present French press reference should be made to the following detailed description of the preferred embodiments. Further, additional features and advantages of the invention are described in, and will be apparent from, the detailed description of the preferred embodiments.

### BRIEF DESCRIPTION OF THE DRAWINGS

FIG. 1 illustrates a perspective view of the lid of the present French press.

FIG. 2 illustrates a perspective view of one of the windows of the present French press.

FIG. 3 illustrates a perspective view of one of the windows of the present French press.

FIG. 4 illustrate a perspective view of one of the windows of the present French press.

FIG. 5 illustrates a perspective view of the underside and interior of the lid of the present French press in one embodiment.

FIG. 6 illustrates a view of the interior wall of the lid of the present French press.

FIG. 7 illustrates a cross-sectional view of the chamber for the removable filter option of the present French press.

FIG. 8 illustrates a perspective view of the front of a filter of the lid of the present French press wherein the filter is in a flat orientation.

FIG. 9 illustrates a perspective view of back the filter of FIG. 8 of the lid of the present French press wherein the filter of FIG. 8 is in a bent orientation.

FIG. 10 illustrates a perspective view of the top of the filter assembly of the present French press wherein the plunger and valve plate are in the closed position.

FIG. 11 illustrates a perspective view of the bottom of the filter assembly of the present French press.

FIG. 12 illustrates a perspective view of the removable reservoir and a main shaft of the present French press.

FIG. 13 illustrates a close-up perspective view of the removable reservoir and the main shaft of the present French press.

FIG. 14 illustrates a perspective view of the bottom of the removable reservoir of the present French press.

FIG. 15 illustrates a perspective view of the removable reservoir of the present French press.

FIGS. 16-18 illustrates views of a plunger of the present French press.

FIG. 19 illustrates a cross-sectional view of the main shaft, the removable reservoir, the plunger and the filter assembly of the present French press. The filter assembly may include the spring plate, top filter, bottom filter and cross plate.

FIG. 20 illustrates a cross-sectional view of the removable reservoir of the present French press secured to the filter assembly.

FIG. 21 illustrates an exploded view of the removable reservoir, the main shaft and the filter assembly of the present French press.

FIG. 22 illustrates a perspective view of the spring plate of the present French press wherein the valve plate is in the closed orientation.

FIG. 23 illustrates a perspective view of the spring plate of the present French press wherein the valve plate is in the open orientation.

FIG. 24 illustrates a cross sectional view of the present French press.

### DETAILED DESCRIPTION OF THE PREFERRED EMBODIMENTS

A French press is provided. The French press has a rotating lid having alternative pour options. Replaceable filters on the lid further allow a user to select the desired filter for use. A movable reservoir located within a housing of the French press traps most, if not all, of the coffee grounds from the interior of the French press. A valve plate stops the brewing process. The device may have two filters which are secured by a spring plate on top, and a cross plate below to form a filter assembly, which separates the coffee grounds from the brew. A plunger holds the filter assembly so that when pressed down, filtered coffee is separated from grounds, with the filter assembly acting as a barrier.

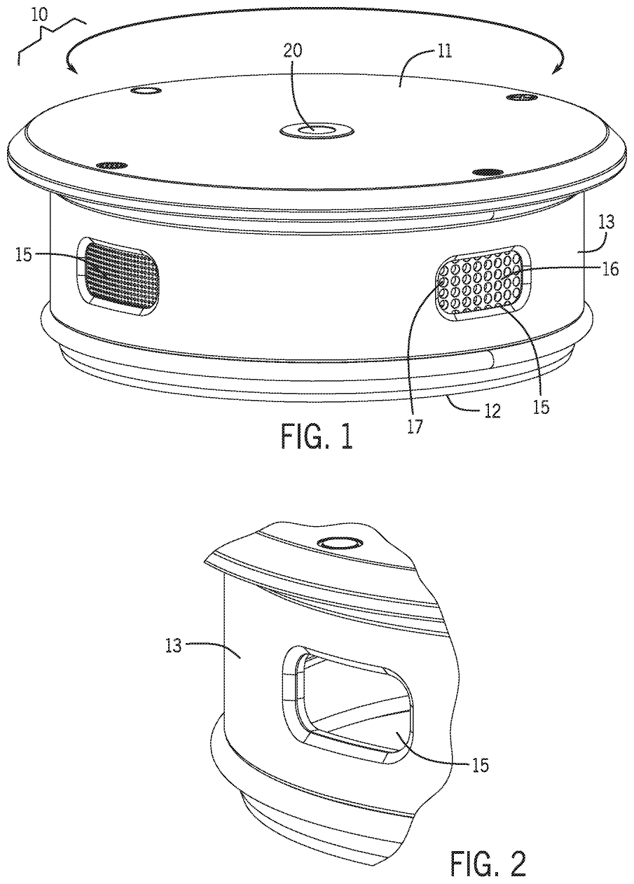

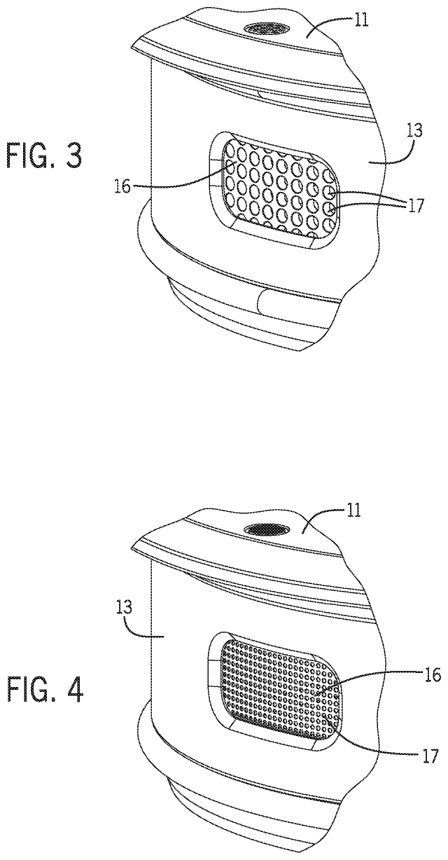

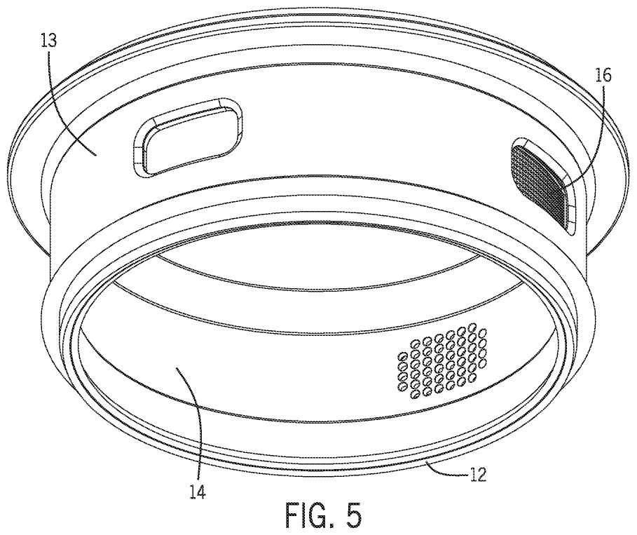

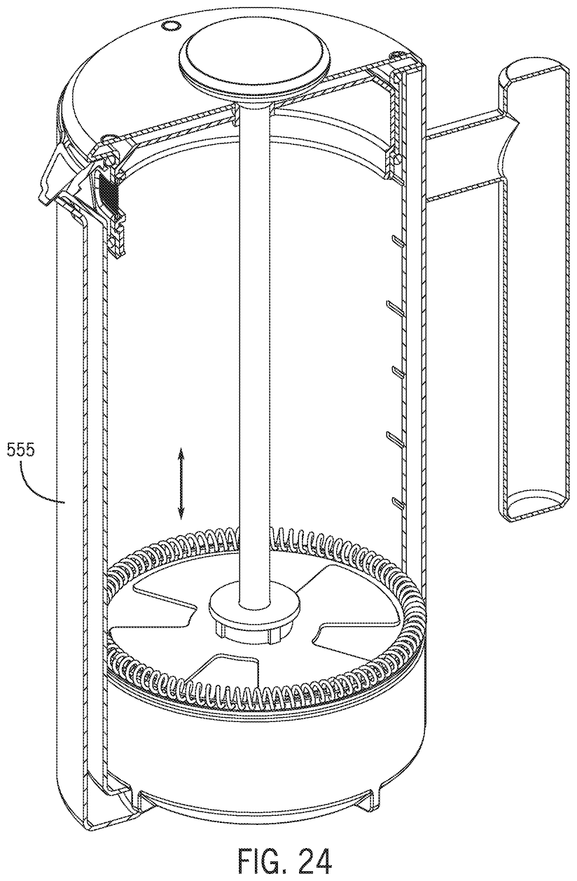

Referring first to FIG. 1, an embodiment, the lid 10 of the present French press 555 (FIG. 24) is provided. Preferably, the lid 10 is circular and made of a durable and non-corrosive material such as plastic or metal. Because the lid 10 is circular, the lid 10 may be rotated three hundred and sixty degrees so as to allow a user to select a desired pouring window 15 as discussed below. In an embodiment, the lid 10 may have a top 11, a bottom edge 12, a generally cylindrical side 13 and a generally hollow interior 14 (FIG. 5).

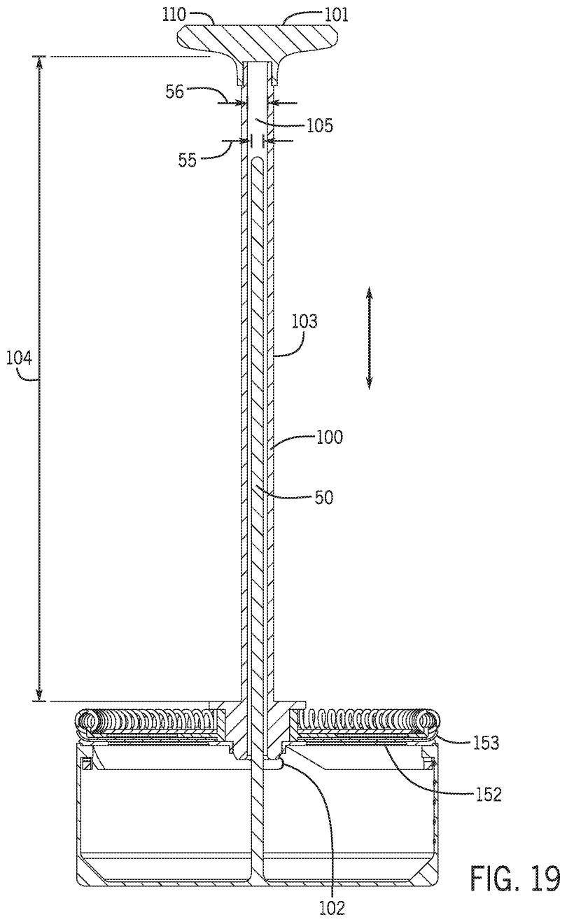

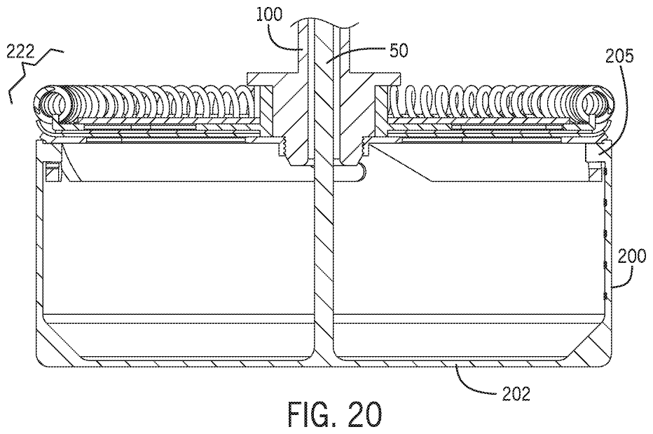

In an embodiment, the generally cylindrical side 13 may have a plurality of windows 15 wherein the plurality of windows 15 may have alternative screen/filter configurations 16. The windows 15 may be aligned with a central opening on the housing of the French press 555 (FIG. 24) so as to allow coffee to be poured from the French press into a cup. The alternative screens/filters 16 may have various sized holes 17 which may allow a user to select between pouring options and styles. In particular, a user may select, for example, a screen/filter 16 with larger holes 17 if the user desires a faster pour of coffee. The smallest holes 17 may be small enough to filter out some coffee grounds which might escape into the brew. In an embodiment, one of the windows 15 (as shown in FIG. 2) may even completely lack a screen/filter 16 so as to allow the coffee located within the interior of the French press to exit the French press without restriction. Finally, in an embodiment, the center of the top 11 of the lid 10 may have a centralized opening 20 which may receive a plunger 100 (as illustrated in FIG. 19 and further described below). FIG. 20, illustrates a filter assembly 222 of the present French press wherein the filter assembly 222 may include a spring plate, a top filter, a bottom filter and a cross plate.

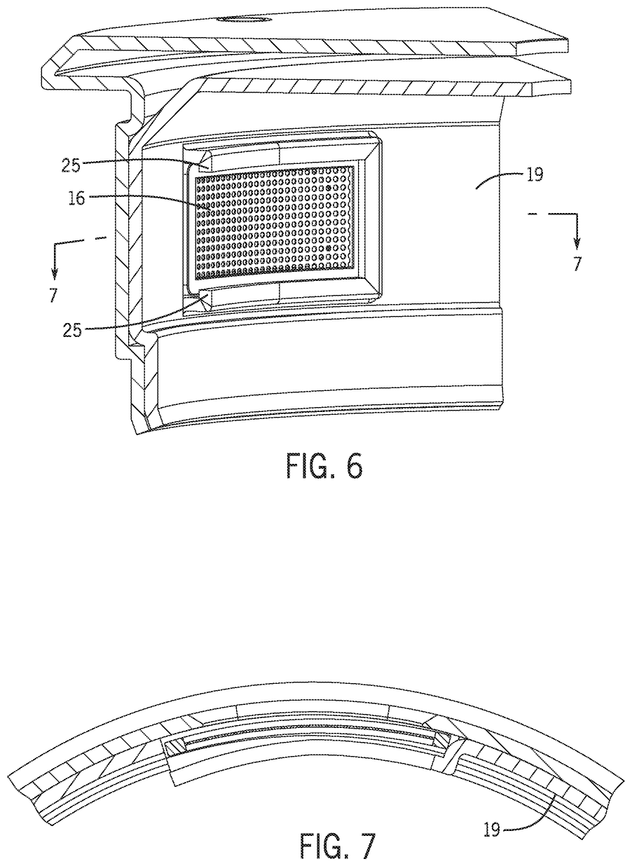

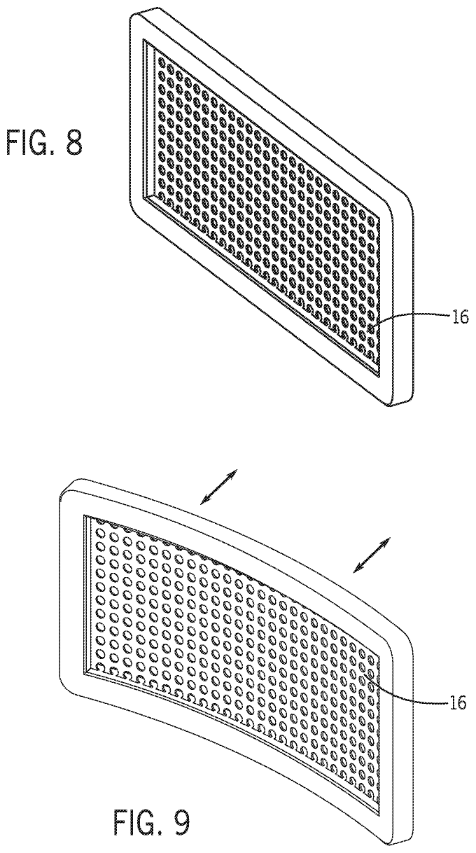

Referring now to FIGS. 6-9, in an embodiment, a user may select between and may switch or replace the alternative screens/filters 16. In particular, a user may elect to change or replace the screens/filters 16 of the lid 10 by, for example, sliding the screens/filters 16 into a rail system 25 (FIG. 6) secured to an interior side wall 19 of the lid 10. The rail system 25 may temporarily secure the top and the bottom of the screen/filter 16 and may prevent the screen/filter 16 from inadvertently shifting or moving. In an embodiment, the screens/filters 16 may be slightly flexible so as to move from a generally flat orientation (FIG. 8) to a bent orientation (FIG. 9) so as to be able to be secured to the curved interior side wall 19 of the lid 10 in a usable orientation. In one alternative embodiment, as illustrated in FIG. 5, the rail system 25 may be lacking and the lid 10 may simply have various permanent filters in the windows 15.

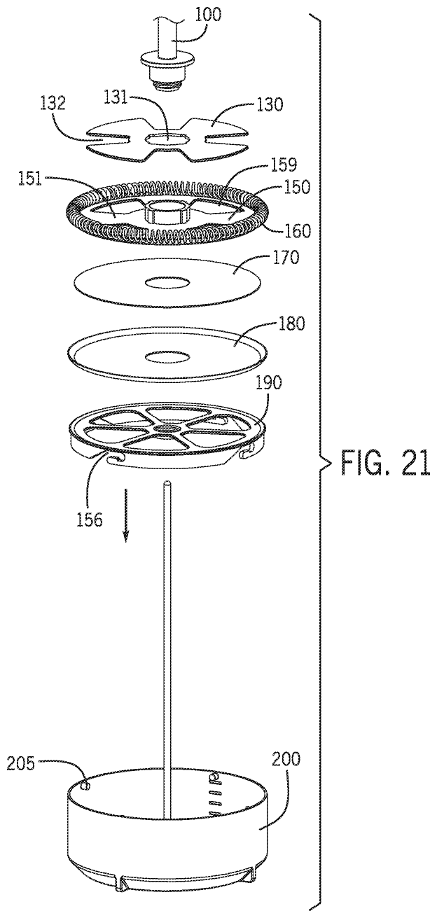

Referring now to FIG. 21, in an embodiment, in addition to the lid 10, the present French press may have a plurality of additional components. In particular, the present French press may have a plunger 100, a valve plate 130, a spring plate 150 having a spring 160, a first filter 170, a second filter 180, a cross plate 190 and a removable reservoir 200 (or “coffee catcher”).

In an embodiment, the spring (or coil) 160 may have a dual purpose. Specifically, the spring 160 may: 1) prevent coffee grounds from escaping through the sides of the filter into the filtered coffee and 2) may secure the plunger/filter assembly 222 firmly to the French press wall, preventing the filter assembly 222 from moving or tilting, while pouring coffee. The two filters 170, 180 may further provide double filtration. Double filtration eliminates most of the finer coffee sediments and results in a cleaner, more flavorful brew.

As illustrated in FIG. 19, the plunger 100 may have a top 101, a bottom 102 (or “extended lip”) and a generally cylindrical side 103. The plunger 100 may further have a length 104 which is slightly shorter than the overall height of the French press housing (FIG. 24). Further, the plunger 100 may have a hollow interior 105 wherein the hollow interior 105 receives the main shaft 50 as described below. In particular, the plunger 100 may be placed over the main shaft 50 as a result of the main shaft 50 having a width 55 which is slightly smaller than the width 56 of the hollow interior 105 of the plunger 100. In an embodiment the plunger 100 may have a handle 110 located at the top 101 of the plunger 100 so that a user may easily grasp and move the plunger 100 from a first position wherein the handle 110 is located well above the lid 10 to a second position wherein the handle 110 is located near the lid 10.

In an embodiment, the present French press may have a valve plate 130. In an embodiment, as illustrated in FIG. 21, the valve plate 130 may have a center opening 131 for receiving both the main shaft 50 and the plunger 100. Further, the valve plate 130 may have a plurality of indentations 132 located on the side of the valve plate 130. Although the figures generally illustrate four indentations 132 on the valve plate 130, any number of indentations 132 may be utilized. In an embodiment, the valve plate 130 is generally flat and made of a durable material such as durable plastic and/or metal.

In an embodiment, the present French press may also have a spring plate 150. The present spring plate 150 may have a top 151, a bottom and a generally cylindrical side 153. In an embodiment the spring plate 150 may be generally circular. The spring plate 150 may have a plurality of openings 159 of similar shape and size as the indentations 132 of the valve plate 130. Preferably, the diameter of the valve plate 130, the spring plate 150, the first filter 170, the second filter 180, the cross plate 190 and the removable reservoir 200 are substantially similar to each other and also slightly smaller than, an interior diameter of the French press so that these elements generally prevent coffee grounds from passing around these elements within the interior of the French press.

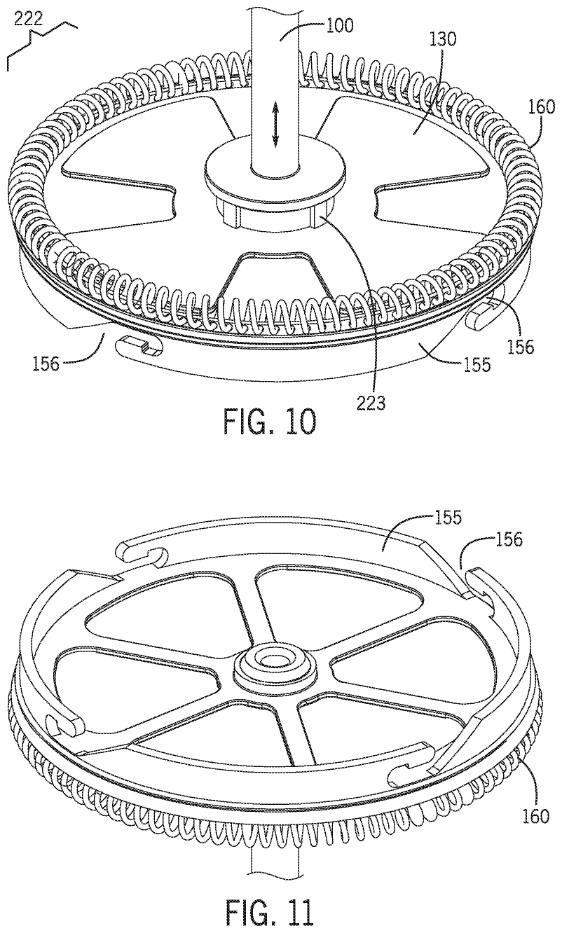

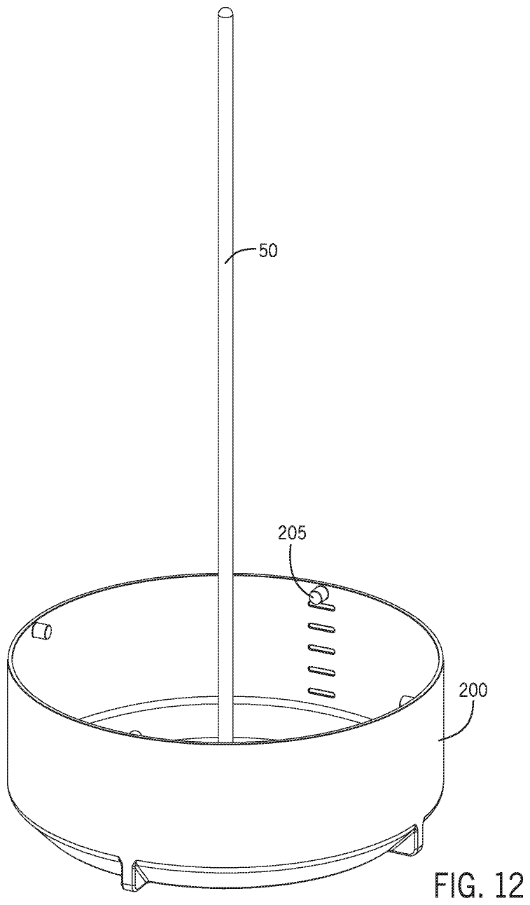

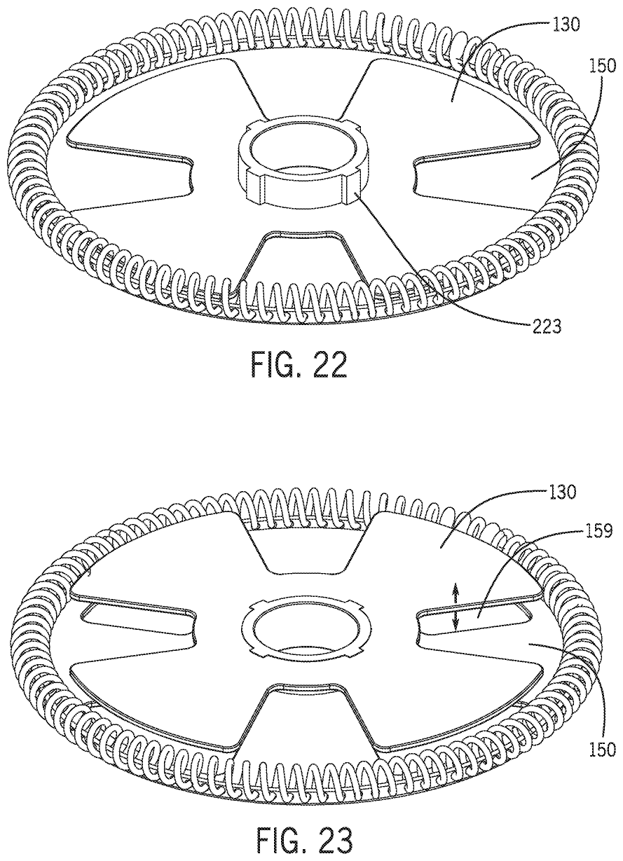

Referring now to FIGS. 22 and 23, in an embodiment, the valve plate 130 may slide up or down (from the first position of FIG. 23 to the second position of FIG. 22) with respect to the spring plate 150. More specifically, as stated above, the spring plate 150 may have openings 159 which allow coffee to pass through. Before pressing down on the plunger 100, the valve plate 130 is in a closed position of FIG. 22. Pressing down on the plunger 100 causes the valve plate 130 to open. More specifically, as the plunger 100 is pressed down, upward pressure from the fluid (coffee brew) below the filter assembly 222 forces the valve plate 130 to slide up along a valve guide 223 (FIG. 10) into an open position of FIG. 23 with respect to the spring plate 150. When the plunger 100 is fully depressed and coffee no longer is providing upward pressure, gravity on the fluid (filtered coffee) above exerts a downward pressure on the valve plate 130, forcing the valve plate 130 to slide down along the valve guide 223 into the closed position of FIG. 22. The valve guide 223 may allow the valve plate 130 to move vertically, but not horizontally with respect to the spring plate 150. An extended lip (as illustrated in FIG. 10) may be located above the valve guide 223. The extended lip may have a greater circumference than the plunger 100 and may stop the valve plate 130 from moving vertically beyond a predetermined point.

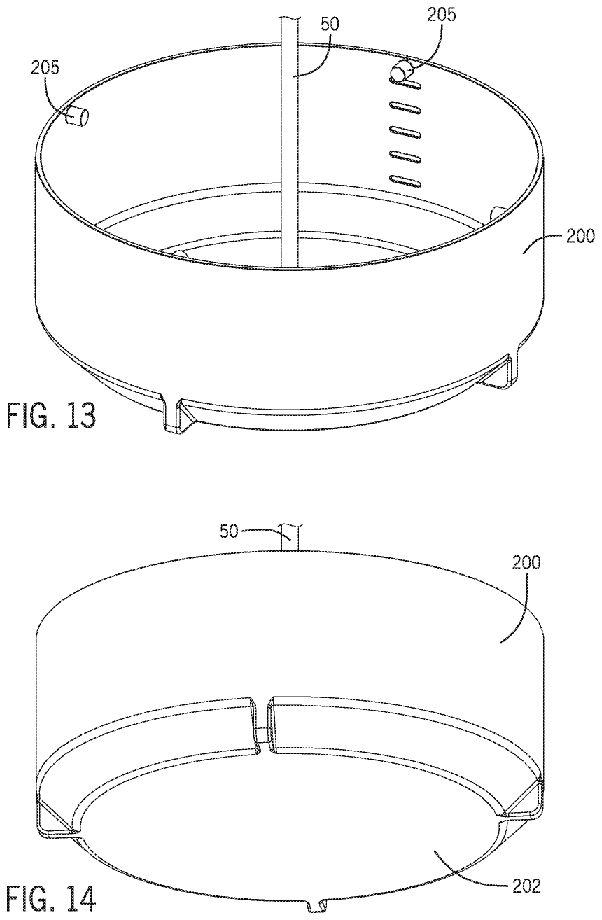

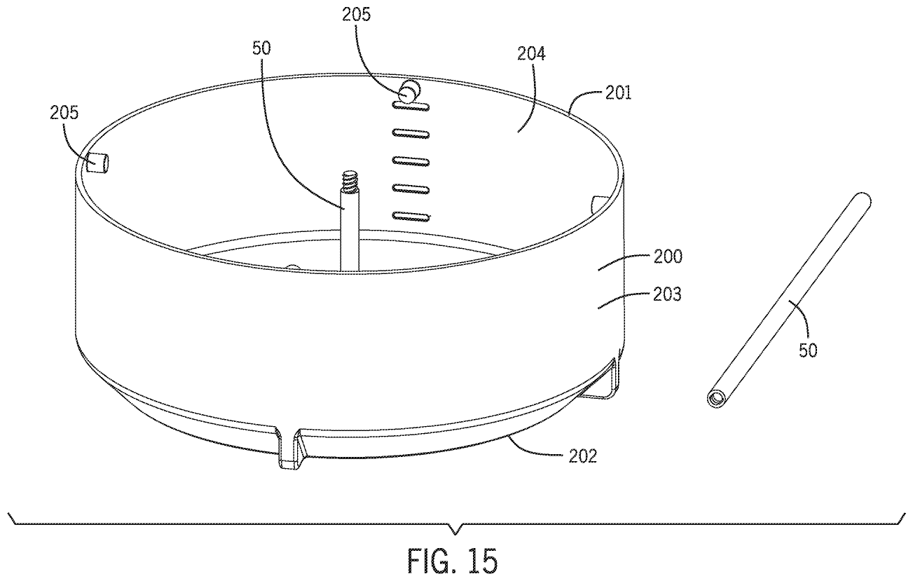

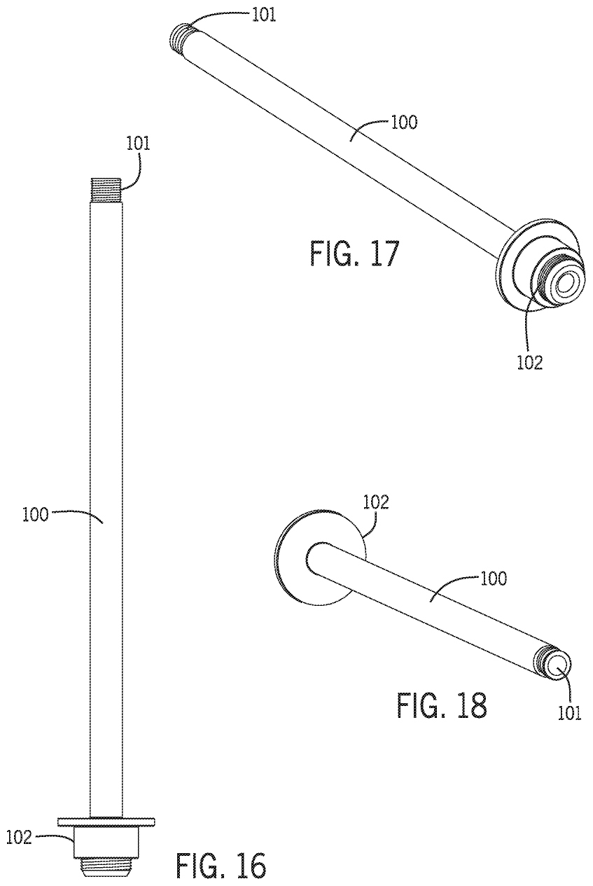

Referring now to FIGS. 13-15, in an embodiment, the main shaft 50 of the present French press may be at least partially removable from the removable reservoir 200 of the French press. The main shaft 50 may be partially detachable so as to avoid interference with the plunger 100. In an embodiment, the removable reservoir 200 may have a top edge 201, a bottom surface 202, a generally cylindrical side 203 and a generally hollow interior 204. The generally hollow interior 204 of the removable reservoir 200 may be placed inside the French press 555 and may rest at the bottom interior of the French press 555 prior to introducing water into the French press 555. As coffee grounds are brewed by the French press 555, the undissolved grounds may fall, via gravity, or forced down by plunging the filter assembly 222, into the removable reservoir 200. Once brewing is completed, the removable reservoir 200 may be removed from the interior of the French press 555 and the remaining coffee grounds in the removable reservoir 200 may be discarded.

Finally, in an embodiment, the removable reservoir 200 may have a plurality of extended pegs 205 located at or near the top edge 201 of the removable reservoir 200. The figures illustrate four extended pegs 205; however a greater number or a fewer number of extended pegs 205 may be utilized. The extended pegs 205 may extend into the interior of the removable reservoir 200 where they may be temporarily locked to an opening 156 (FIGS. 10 and 11) of a bottom ridge 155 of a bottom 152 (FIG. 19) of the cross plate 190. In particular, the filter assembly 222 may be pushed down, via the plunger 100, until the openings 156 of the cross plate 190 contact the extended pegs 205 of the reservoir 200 as is shown in FIG. 24. The cross plate 190 may then be slightly rotated by turning the handle 110 of the plunger 100 so that the extended pegs 205 lock into the openings 156 of the bottom edge 155 of the cross plate 190. Once the spring plate 150 is locked into place via the pegs 205, a user may utilize the handle 110 to pull the removable reservoir 200 upward and out of the interior of the French press 555.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A French press comprising:
a housing having a top, a bottom and a generally hollow interior;
a cylindrical lid having a top and a cylindrical side wherein the cylindrical lid is removable from the housing wherein the lid may be rotated three hundred and sixty degrees with respect to the housing; and
an opening on the cylindrical side of the cylindrical lid wherein the opening is surrounded by a first rail and a second rail wherein the first rail and the second rail together are capable of temporarily receiving a first removable filter which covers the opening.

2. The French press of claim 1 wherein the first rail and the second rail are located on an interior side wall of the cylindrical side of the cylindrical lid.

3. The French press of claim 1 wherein the first removable filter is bendable and may move from a first generally flat orientation to a second curved orientation and wherein the first removable filter is in the curved orientation when slid through the first rail and second rail of the cylindrical lid.

4. The French press of claim 1 further comprising:
at least a second opening on the cylindrical side of the cylindrical lid wherein the second opening has a first rail and a second rail and therein the first rail and the second rail together care capable of temporarily receiving a second removable filter and wherein the second removable filter has holes which are different in size from holes of the first removable filter.

5. The French press of claim 1 further comprising:
a third rail perpendicularly extending between the first rail and the second rail and wherein the first rail and the second rail are parallel to each other and wherein the third rail prevents movement of the first removable filter at a first side of the first removable filter and does not prevent movement at a second side of the first removable filter.

6. A French press comprising:
a housing having a top, a bottom and a generally hollow interior; and
a removable reservoir having an open top, a bottom and a generally hollow interior wherein the removable reservoir has a diameter which is slightly less than a diameter of the housing and wherein the removable reservoir may be removably inserted into the generally hollow interior of the housing and wherein the removable reservoir rests on the bottom of the generally hollow interior of the housing.

7. The French press of claim 6 further comprising:
a removable shaft wherein the removable shaft is removably secured within the generally hollow interior of the removable reservoir at a bottom surface of the removable reservoir.

8. The French press of claim 6 further comprising:
at least one extended peg located along a cylindrical interior side wall of the removable reservoir wherein the extended peg is capable of receiving an opening slot of a movable planar surface and wherein the movable planar surface may pull the removable reservoir upward with respect to the bottom of the housing when the extended peg of the removable reservoir is secured within the opening slot of the movable planar surface and when the movable planar surface is pulled upward with respect to the bottom of the housing.

9. A French press comprising:
a housing having a top, a bottom and a generally hollow interior;
a cylindrical lid having a top and a side located at the top of the housing;
an opening on the top of the cylindrical lid wherein the opening receives a shaft which moves independently from the cylindrical lid;
wherein the shaft has a first end and a second end wherein a handle is located at the first end of the shaft and wherein the first end of the shaft is located outside of the generally hollow interior of the housing; and
wherein the second end of the shaft is temporarily secured to a first planar surface and wherein the first planar surface has at least one opening; and
a second planar surface located between the first planar surface and the first end of the shaft and wherein the second planar surface moves from a first position to a second position with respect to the first planar surface and wherein the second planar surface partially covers the opening of the first planar surface in the first position and substantially prevents a fluid from passing through the opening of the first planar surface in the first position but does not prevent the fluid from passing through the first planar surface in the second position.

10. The French press of claim 9 further comprising:
a top of the first planar surface and bottom of the first planar surface; and
a securing hook on the bottom of the first planar surface wherein the securing hook may temporarily secure a peg located on a removable reservoir located within the generally hollow interior of the housing and wherein the securing hook of the bottom of the first planar surface may lift the removable reservoir from a bottom of the generally hollow interior of the housing when the securing hook is secured to the peg and when the handle is pulled upward.

11. The French press of claim 9 further comprising:
a rail located on the shaft; and
an indentation on the second planar surface wherein the indentation on the second planar surface is of the same size and shape as the rail and wherein the rail allows the second planar surface to move vertically but not horizontally with respect to the first planar surface.

12. The French press of claim 11 further comprising:
an extended lip located on the shaft wherein the extended lip is the terminal point of the rail on one side of the rail and wherein the extended lip prevents the second planar surface from moving vertically beyond the location of the extended lip.

13. The French press of claim 9 further comprising:
a filter located below the first planar surface.

14. The French press of claim 9 further comprising:
a coil surrounding the first planar surface at the circumference of the first planar surface.

15. The French press of claim 9 wherein the second end of the shaft has an opening and wherein the opening telescopically receives a second shaft which is secured to a removable reservoir located within the generally hollow interior of the housing.
